(19) United States
(12) Patent Application Publication
(10) Pub. No.: US 2024/0394109 A1
(43) Pub. Date: Nov. 28, 2024

(54) DYNAMIC TASK ASSIGNMENT

(71) Applicant: Central Mutual Insurance Company, Van Wert, OH (US)

(72) Inventors: Paul J. Edwards, Fort Wayne, IN (US); Jessica L. Pannkuk, Lakeville, MN (US)

(21) Appl. No.: 18/200,839

(22) Filed: May 23, 2023

(51) Int. Cl. G06F 9/50

(52) U.S. Cl. CPC G06F 9/5038; G06F 9/5072; G06F 2209/5022

(57) ABSTRACT

Methods, systems, and apparatus, including computer programs encoded on computer storage media, for dynamic task routing. One of the methods includes: determining, for a task to be performed by a system that includes two or more entity tiers in a tier hierarchy, each tier of which including a multiple entities that can work on tasks and for processing a different complexity of tasks, a complexity of the task; determining whether the complexity of the task satisfies a complexity threshold; and in response to determining that the complexity of the task does not satisfy the complexity threshold, assigning the task to a default tier in the tier hierarchy to enable all of the entities in the default tier to work on different portions of the task.

### BACKGROUND

In systems that complete a number of tasks, the systems can assign tasks to entities within the system.

### SUMMARY

Optimizing resource management can have various positive effects for systems carrying out operations. For systems with multiple entities working in parallel, selectively choosing which entities carry out which subset of the operations can reduce the overall resources used, the time taken to complete the operations, or both. The entities can have or be computational resources, such as different computers, or different cloud computing resources, to name a few examples.

This specification describes a method for resource management tailored for operations that have individual tasks that can vary in complexity and entities with varying capabilities of handling that complexity. For example, rules about assigning the relative number of tasks to the various entities can prevent a particular entity from being over- or under-used. In some examples, rules about escalating an assignment from one tier of entities to another tier based on complexity, when the different entity tiers can provide different types or resources or optimizations, can reduce the overall time taken to complete the assignment. This specification also includes methods for building an engine that can determine the assignments, which can reduce human intervention and allow the engine to evolve over time.

In general, one aspect of the subject matter described in this specification can be embodied in methods that include the actions of: determining, for a task to be performed by a system that includes two or more entity tiers in a tier hierarchy, each tier of which including a multiple entities that can work on tasks and for processing a different complexity of tasks, a complexity of the task; determining whether the complexity of the task satisfies a complexity threshold; and in response to determining that the complexity of the task does not satisfy the complexity threshold, assigning the task to a default tier in the tier hierarchy to enable all of the entities in the default tier to work on different portions of the task.

In general, one aspect of the subject matter described in this specification can be embodied in methods that include the actions of: determining, for a task to be performed by a system that includes two or more entity tiers in a tier hierarchy each tier of which includes a multiple entities that can work on tasks and for processing a different complexity of tasks, one or more complexity rules that apply to the task; determining, using data for the one or more complexity rules, whether one of the complexity rules indicates that an entity in a default tier should process the task; in response to determining that none of the complexity rules indicates that an entity in the default tier should process the task, identifying, using data for the one or more complexity rules, a highest level tier that is indicated by at least one of the one or more complexity rules; and assigning the task to the identified highest level tier that is indicated by at least one of the one or more complexity rules.

In general, one aspect of the subject matter described in this specification can be embodied in methods that include the actions of: determining, for each of two or more entities that can perform a task, a number of tasks already assigned to the entity; determining, using the number of tasks already assigned to the two or more entities, a task deviation between a first entity with a greatest number of already assigned tasks and a second entity with a lowest number of already assigned tasks; selecting, from the two or more entities and using the number of tasks already assigned to each of the two or more entities and the task deviation between the first entity with the greatest number of already assigned tasks and the second entity with the lowest number of already assigned tasks, an entity to which to assign the task; and assigning the task to the entity to cause the entity to work on the task.

Other implementations of this aspect include corresponding computer systems, apparatus, computer program products, and computer programs recorded on one or more computer storage devices, each configured to perform the actions of the methods. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

The foregoing and other implementations can each optionally include one or more of the following features, alone or in combination.

In some implementations, assigning the task to default tier includes assigning the task to two entities of the multiple entities for the default tier.

In some implementations, assigning the task to default tier includes assigning the task to all of the entities of the multiple entities for the default tier.

In some implementations, assigning the task to the default tier in response to determining that the complexity of the task does not satisfy the complexity threshold includes sending, to at least one entity in the default tier, assignment data that indicates that at least one entity from the multiple entities for the default tier will retrieve input data from a source of the task.

In some implementations, assigning the task to the default tier in response to determining that the complexity of the task does not satisfy the complexity threshold includes sending, to at least one entity in the default tier, assignment data that indicates that entities from the multiple entities for the default tier are the only entities that will retrieve input data from a source of the task.

In some implementations, data associated with the task is stored in a database for a reduced period of time, the reduced period of time being less than a period of time during which the data associated with the task would have been stored in the database if the task was assigned to a tier other than the default tier.

In some implementations, identifying, using the data for the one or more complexity rules, the highest level tier that is indicated by at least one of the one or more complexity rules includes: identifying, using first data for a first complexity rule from the one or more complexity rules, a first tier in the tier hierarchy; identifying, using second data for a second complexity rule from the one or more complexity rules, a second tier in the tier hierarchy that processes more complex tasks than the first tier; and selecting, as the highest level tier, the second tier from the tier hierarchy that processes more complex tasks than the first tier.

In some implementations, the method further includes assigning a data input process to the default tier to cause at least one entity in the default tier to retrieve, from a source of the task, input data for the task. Assigning the task to the identified highest level tier that can be indicated by at least one of the one or more complexity rules in response to determining that none of the complexity rules indicates that an entity in the default tier should process the task includes sending, to at least one entity in the identified highest level tier, assignment data to cause an entity from the identified highest level tier to retrieve additional input data from the source of the task.

In some implementations, the default tier includes a lowest level tier in the tier hierarchy that is assigned tasks that do not satisfy a lowest complexity threshold.

In some implementations, the identified highest level tier is a highest level in the tier hierarchy that is assigned tasks that satisfy a highest complexity threshold.

In some implementations, the identified highest level tier is not a highest level in the tier hierarchy.

In some implementations, the method further includes determining, for a task, a complexity of the task. Determining the number of tasks can include determining, for each of the two or more entities that can perform the task given the complexity of the task, the number of tasks already assigned to the entity.

In some implementations, selecting an entity to which to assign the task uses a round-robin technique for the two or more entities.

In some implementations, a tier that includes the two or more entities can be part of a tier hierarchy each tier of which includes a multiple entities that can work on tasks and for processing a different complexity of tasks. Selecting the entity to which to assign the task can include: determining whether assigning the task to an entity of the two or more entities within the tier would violate one or more assignment rules; and in response to determining that assigning the task to an entity of the two or more entities within the tier would not violate one or more assignment rules, determining to skip escalating the task to a higher tier than the tier within the tier hierarchy.

In some implementations, at least one of the one or more assignment rules requires that a number of tasks assigned to a particular entity within a time period satisfies a task threshold.

In some implementations, the task threshold is determined dynamically according to the at least one of the one or more assignment rules and tasks assigned to one or more of the two or more entities in the tier.

In some implementations, the task threshold is determined using user input.

In some implementations, the time period is a day.

In some implementations, the at least one of the one or more assignment rules require that the task deviation between two entities within the tier satisfies a deviation threshold.

The subject matter described in this specification can be implemented in various implementations and may result in one or more of the following advantages. Using the disclosed methods or systems to assign tasks to entities can result in reduced resources, e.g., computer resources, time, human intervention, or a combination of these, used in carrying out the tasks. Preventing overuse of entities, e.g., without sacrificing speed, can increase the longevity of the system. In some implementations, the systems and methods described in this specification can more accurately assign tasks to an entity tier, which can result in more efficient processing of the task, e.g., reduced resource usage. In some implementations, more accurately assigning tasks to an entity tier can result in higher quality completion of tasks, e.g., fewer errors or mistakes being made in the completion of the task. In some implementations, a number of tasks can be performed such that they satisfy an efficiency threshold, indicating that the system is more quickly completing tasks compared to other systems.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 depicts a system for dynamic task routing.

FIG. 2 is a flow diagram of a process for assigning tasks.

FIG. 3 is a flow diagram of a process for dynamically assigning tasks.

FIG. 4 is a block diagram of a computing system that can be used in connection with computer-implemented methods described in this specification.

Like reference numbers and designations in the various drawings indicate like elements.

### DETAILED DESCRIPTION

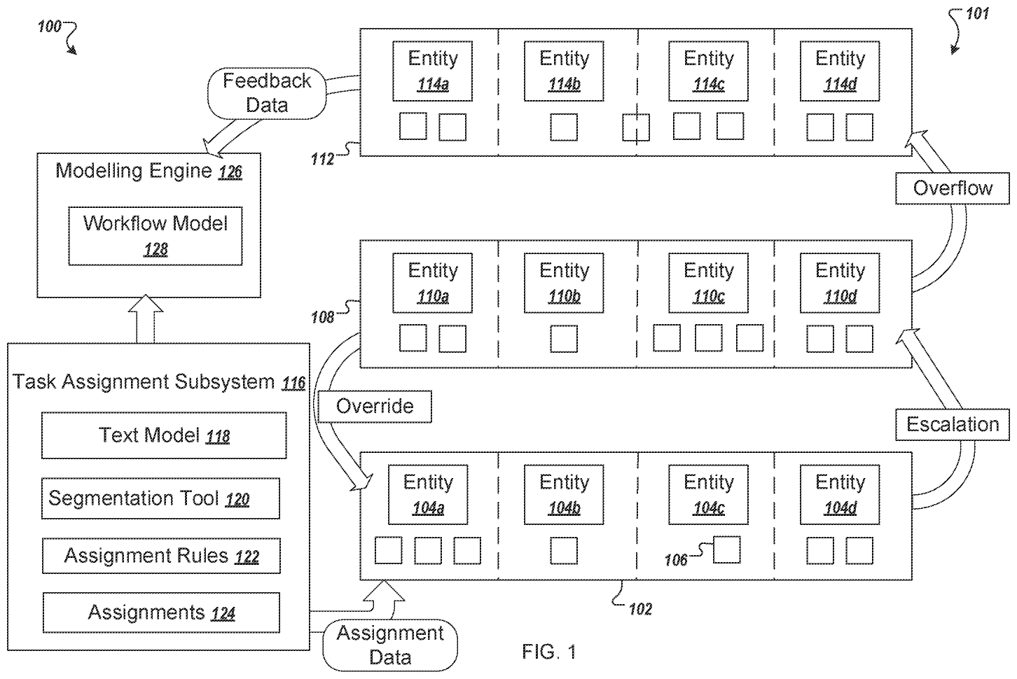

FIG. 1 depicts a system 100 for dynamic task routing. The system 100 includes a tier hierarchy 101, which includes multiple tiers, e.g., tiers 102, 108, and 112. Each tier can correspond to different skills, capabilities, and functionalities of the entities in the respective tier associated with completing a task. Within each tier are multiple entities, e.g., first through fourth entities 104a-d, fifth through eighth entities 110a-d, ninth through twelfth entities 114a-d. In some implementations, within a tier, e.g., tier 102, all of the entities, e.g., entities 104a-d, have at least some of the same skills, functionalities, and capabilities. In some implementations, the entities are or have computers. For instance, the entities 104a-d, 110a-d, and 114a-d can be shards in a cloud computing environment, or other appropriate types of computers that can process various ones of the tasks.

The system 100 can assign incoming tasks 106 with varying complexity, urgency, or both, using the task assignment subsystem 116. The task assignment subsystem 116 can use one or more of a text model 118, a segmentation tool 120, or assignment rules 122 to determine assignments 124.

An assignment 124 is data that identifies a task 106 and the entity that is assigned to at least partially complete the task. In some implementations, the task assignment subsystem 116 assigns a single task 106 to more than one entity. Assignment data can include input data associated with the tasks, e.g., data that was received from a customer, was processed using the text model 118, data that will be used to complete the task, or a combination thereof.

The task assignment subsystem 116 can send the assignment data to a tier within the tier hierarchy 101. Using the assignment data, which can include the assignments 124, the system 100 can distribute the tasks to entities within each tier. For example, a first entity 104a in the first tier 102 can have three tasks 106, a second entity 104b in the first tier 102 can have two tasks 106, and a fifth entity 110a in the second tier 108 and have two tasks 106.

The task assignment subsystem 116 can use the text model 118 to determine information about an incoming task from text associated with the task 106. For example, a task 106 can be associated with various documents, e.g., input documents. The text model 118 can process the documents to determine key phrases in the documents, dates associated with the documents, and other information about a corresponding task. For example, task assignment subsystem 116 can use the text model 118 to determine that the due date of the task is tomorrow. The text model 118 can receive various formats of input data, e.g., text documents, images, emails, and the like.

The segmentation tool 120 can use information about the task to determine properties, e.g., complexity, urgency, severity, line of business, or a combination of two or more of these, that will be used by the assignment rules 122. Using the previous example, the segmentation tool 120 can use the due date being tomorrow to determine that the task is urgent. As another example, the task assignment subsystem 116 can use the segmentation tool 120 to determine that the task is “complex,” e.g., different documents associated with the task have differing values for a field, such as a name, that an entity will have to resolve. In some examples, complexity can reflect the projected amount of computer resources expected to be used or time spent to complete the task. In some examples, the segmentation tool 120 uses multiple types of information to determine the complexity. For example, the segmentation tool 120 can determine the task is highly complex when there is a discrepancy in the associated customer name between different documents and the projected amount of computer resources is higher than a predetermined amount.

The assignment rules 122 can include various types of rules, e.g., escalation, overflow, override, or a combination of these. Some of the assignments rules 122 can include complexity rules that are used to analyze one or more properties of a task's complexity. Although any particular example might refer to escalation, overflow, or override rules, all of these rule types can be included as examples of complexity rules.

The task assignment subsystem 116 uses escalation rules and information relating to the complexity of the given task to determine what level tier is the most appropriate for handling a task. For example, the first tier 102 can include entities 104a-d that are trained to handle “simple” tasks, e.g., tasks that can be completed by determining the answer to multiple choice questions or text mining or use less than a threshold amount of computational resources. If a given task is simple, the escalation rules can cause the task assignment subsystem 116 to determine that a default tier, e.g., the first tier 102, is the most appropriate tier, as there is no need to escalate the task to a higher tier.

The task assignment subsystem 116 assigns a task to the default tier unless an entity from another tier is assigned to work on a task. The task will be assigned to an entity, or possibly multiple entities, in the default tier. The default tier can satisfy a lowest complexity threshold of all of the tiers, e.g., for each tier the complexity can be no higher than a particular complexity threshold, and the complexity threshold of the default tier can be the lowest of all of the tiers. The highest level in the tier hierarchy can satisfy have the highest complexity threshold, process tasks of any complexity, or both.

In some implementations, if a given task has a medium complexity, e.g., satisfies a complexity threshold, the escalation rules can cause the task assignment subsystem 116 to determine that the second tier 108 is the most appropriate tier for handling the task.

In some implementations, entities in the default tier are trained, designed, or otherwise configured to handle simple tasks more efficiently than other tiers. For example, the assignment rules 122 can assign a disproportionate amount of tasks to the first tier 102, as the first tier 102 can complete simple tasks more quickly compared to the second and third tiers 108 and 112.

In some implementations, completing a task in the default tier utilizes reflexive questioning. For example, completing a task can include selecting as few questions as possible to present to a user to gather the required data to complete the task. For example, when multiple text data inputs are required for completing a particular task, an entity within the default tier, or another system, can select a single question relating to one type of data to present if it is possible to acquire the remaining types of input data in an accessible database given the response to the single question or other questions are determined to not apply to the task.

In some implementations, the escalation rules can assume that the default tier is not the first tier 102. For example, when the entities in the first tier 102 have at least a threshold number of tasks assigned to them, individually or as a group, the escalation rules can select, as the default tier, the next lowest tier that does not satisfy the threshold number of tasks assigned, e.g., the second tier 108.

In some implementations, multiple escalation rules can be satisfied for a task, e.g., apply to the task. When multiple escalation rules are satisfied, the task assignment subsystem 116 can assign the task to a tier that satisfies all of the escalation rules, or that is the highest tier for any of the satisfied escalation rules. For example, the task can involve a particular type of computation that only entities within at least the second tier can accomplish, e.g., fifth through eighth entities 110a-d and ninth through twelfth entities 114a-d. Only these entities can accomplish this task given the resources those entities have, e.g., memory or power resources. In some examples, the resources can include computational models. The task can involve another type of computation that only entities within the third tier could accomplish, e.g., entities 114a-d. In this scenario, the task assignment subsystem 116 can assign the task to the third tier 112.

The assignment rules 122 can include rules for assigning tasks within a tier, where the rules do not necessarily depend on complexity of the task. The rules for assigning tasks can be rules used to assign tasks to particular entities, e.g., within a tier. For example, the assignment rules 122 can suggest that the entities 104a-d can have no more than a fixed deviation in task assignments, e.g., three tasks, during a time period. In some implementations, the deviation in task assignment can be quantified by percentage difference, an exact number of tasks, or both. For instance, the maximum percent difference between the number of assigned tasks assigned to the entities with the most and least assigned tasks can be about 25%. The maximum percent difference can be selected to balance advantages and disadvantages of entities disproportionately being assigned tasks.

In some implementations, the task threshold is predetermined dynamically by the system 100. For example, a modelling engine 126, described in more detail below, can determine the task threshold that results in the most tasks being completed in a time period. In some implementations, the task threshold is determined by user input. For example, the task assignment subsystem 116 can receive user input that specifies a maximum number of tasks allowed per entity within a time period. In some implementations, the time period is a day.

As another example, the assignment rules 122 can suggest that an entity can be assigned no more than a certain number of urgent tasks at a time, e.g., tasks with a deadline that satisfy a deadline threshold.

In some implementations, the assignment rules within a tier can be tier specific. For example, the maximum allowed difference in task assignment between entities can vary from tier to tier.

In some implementations, the assignment rules 122 for assigning tasks within a tier can be used to assign tasks based on efficiencies of entities within the tier. For example, a first entity within a tier can include a more powerful computer than the rest of the entities of the tier. Accordingly, the assignment rules 122 can disproportionally assign tasks to the first entity compared to the other entities while still satisfying other assignment rules 122, e.g., not exceeding a predetermined difference in assignments between entities within the tier.

In some implementations, multiple entities can work on the same task. For example, entities 114b and 114c from the third tier 112 can work on different portions of the same task. In some implementations, tasks assigned to entities the default tier, e.g., first tier 102, can be, e.g., are generally, assigned to multiple entities. For example, the default tier can have entities trained to handle simple tasks that can be split up and completed by multiple entities. In this example, the task can involve four calculations, the output of which do not depend on each other. The task assignment subsystem 116 can determine to assign each of the four calculations to a corresponding entity (first, second, third, and fourth entities 104a), e.g., parallelize the task, since the four calculations can run simultaneously. Accordingly, splitting up simple tasks to assign to multiple entities within the default tier can reduce an amount of time taken to complete a task.

In some implementations, entities from different tiers can work on different portions of the same task. In some implementations, multiple entities can work on the same portions of the given task, e.g., to compare the output of the tasks, to complete the portion or quickly, or both.

In some implementations, the assignment rules 122 include a requirement that a task is assigned to no more than a single entity within a single tier, e.g., avoid duplication of work. The task assignment subsystem 116 can assign a task to a single entity when the task is more complex, is less time sensitive than other tasks, or a combination of both.

In some implementations, the task assignment subsystem 116 can assign a task to a tier other than the first tier 102, or the default tier, and still have at least one entity in the first tier 102 perform at least some of the work on the task. For example, the task assignment subsystem 116 can determine that a task is highly complex and assign the task to be completed by ninth entity 114a in the third tier 112. However, the task can include some portions that are simple and can be completed by an entity in the default titer, e.g., the first entity 104a in the first tier 102, more efficiently. For example, a task could involve a simple calculation or input that does not require high accuracy and a highly complex calculation that does require high accuracy. Entity 104a can be a relatively low-resource-intensive computer that can perform relatively low accuracy calculations, e.g., given floating point rounding, and entity 114a can be a relatively high-resource-intensive computer that can perform relatively high accuracy calculations. Since the simple calculation of the task does not require high accuracy, allowing entity 104a to perform the simple calculation, instead of having entity 114a complete the entire task, can be more resource efficient. In some implementations, the entities within the default tier can be more efficient at retrieving input data than the other entities. Accordingly, in some implementation, only entities from the default tier can be assigned to retrieve input data in the completion of a task.

The task assignment subsystem 116 uses the overflow rules to determine whether a particular tier might be assigned too many tasks given the resources of that tier. The task assignment subsystem 116 can use the overflow rules and information about the complexity of the task and the number of tasks assigned within a tier to determine whether to “overflow” to a higher tier. For example, using the escalation rules, the task assignment subsystem 116 can determine to assign a task to an entity within the second tier 108. However, the fifth through eighth entities 110a-d within the second tier 108 can satisfy an assignment threshold, e.g., be at the limit of assignment requirements according to the overflow rules. If the fifth through eighth entities 110a-d within the second tier 108 are maximally occupied, the task assignment subsystem 116 can use the overflow rules to assign the task to the next tier, e.g., third tier 112. Since the tasks overflow to a higher tier, an entity capable of handling a task of at least the complexity of the task completes the task.

In some implementations, the overflow rules only assign an entire task, rather than a portion of a task, to an entity in the next tier.

The override rules can trump the overflow and escalation rules, e.g., even if the escalation and overflow rules suggest that a task should be assigned to the second tier 108. For instance, when an override rule applies to a task, the task assignment subsystem 116 can “override” the escalation and overflow rules, assigning the task to an entity within the first tier 102. The override rules can include, for example, if a task satisfies a minimum complexity threshold, includes confidential information, or both, only the first tier 102 can handle the task. In some examples, the override rules can indicate when a task should be assigned to the default tier.

When a task is assigned to an entity in a tier, the entity can start completing the task. Completing the task can include performing an operation, performing a calculation, retrieving data, training an algorithm, building a model, and the like. In some examples, completing the task can include providing output data, e.g., to a device or system.

The task assignment subsystem 116 can provide some or all of the assignment data to an entity to which a task is assigned. Assignment of the task, e.g., provision of the task assignment data, can cause the entity or entities to which the task is assigned to perform actions for the task, such as those actions described above.

The system 100 can use the modelling engine 126 to update a workflow model 128 for the task assignment subsystem 116. The system 100 can use the updated workflow model 128 to improve task assignments to the entities in the tier hierarchy 101. This can improve resource usage, processing time, or both.

The task assignment subsystem 116 can provide data about the assignments 124, data about completed tasks, or both, to the modelling engine 126. The tier hierarchy 101 can provide data about completed tasks to the modelling engine 126. The data about completed tasks can reflect changes made in task assignments to entities in real time, e.g., discrepancies between the assignments 124 and the actual assignments as processed by the entities. For example, tasks can be reassigned by task assignment subsystem 116 after a task has been initially assigned or the task assignment subsystem 116 can indicate that a task is complete, e.g., closed, before an assigned entity completes the task.

Using the assignments 124 and the completed assignment data, the modelling engine 126 can generate, update, or both, a workflow model 128. The workflow model 128 can dynamically perform task assignment, as the rules of the workflow model 128 can be continuously updated using the assignments 124 and the feedback data.

In some implementations, the completed assignment data includes output from the tasks, e.g., whether a task was successfully completed, resources used in completing the task, costs associated with completing the task, follow-up tasks that result from the task being completed, or a combination of two or more of these.

The system 100 can be a system implemented as computer programs on one or more computers in one or more locations, in which the systems, components, and techniques described in this specification are implemented. The entities can include personal computers, mobile communication devices, and other devices that can send and receive data over a network. The network (not shown), such as a local area network (“LAN”), wide area network (“WAN”), the Internet, or a combination thereof, connects the entities within the tier hierarchy 101, the task assignment subsystem 116, the modelling engine 126, and the system 100. The system 100 can use a single server computer or multiple server computers operating in conjunction with one another, including, for example, a set of remote computers deployed as a cloud computing service.

The system 100 can include several different functional components, including the tier hierarchy 101, the task assignment subsystem 116, the segmentation tool 120, and the modelling engine 126. The tier hierarchy 101, the task assignment subsystem 116, the segmentation tool 120, the modelling engine 126, or a combination of these, can include one or more data processing apparatuses, can be implemented in code, or a combination of both. For instance, each of the tier hierarchy 101, the task assignment subsystem 116, the segmentation tool 120, and the modelling engine 126 can include one or more data processors and instructions that cause the one or more data processors to perform the operations discussed herein.

The various functional components of the system 100 can be installed on one or more computers as separate functional components or as different modules of a same functional component. For example, the computer and storage device of the system 100 can be implemented as computer programs installed on one or more computers in one or more locations that are coupled to each through a network. In cloud-based systems for example, these components can be implemented by individual computing nodes of a distributed computing system.

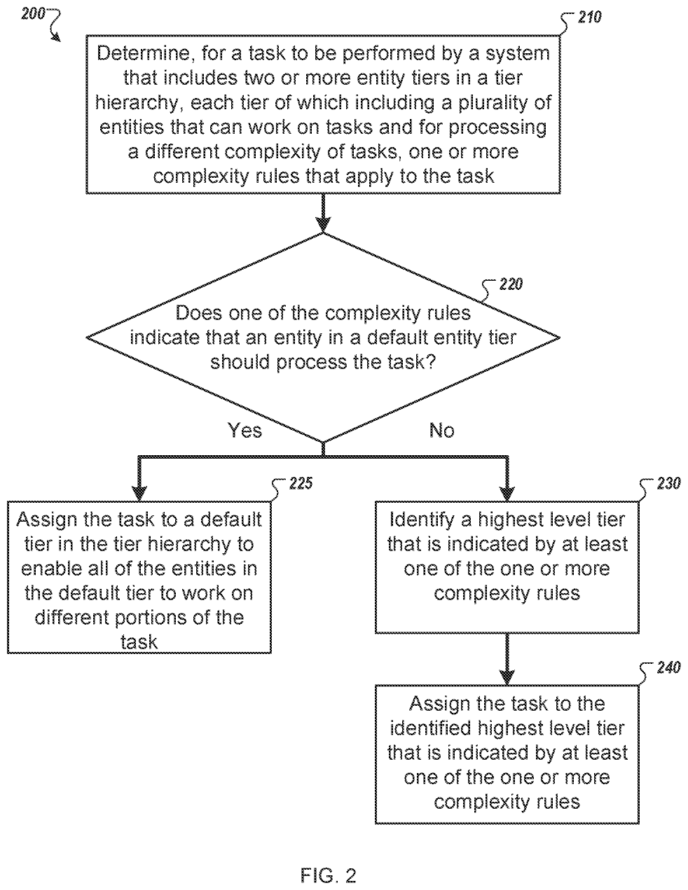

FIG. 2 is a flow diagram of a process 200 for assigning tasks 106. For example, the process 200 can be used by the system 100, e.g., using the task assignment subsystem 116.

The task assignment subsystem 116 can determine, for a task to be performed by the system 100 that includes two or more entity tiers in a tier hierarchy, each tier of which including a plurality of entities that can work on tasks and for processing a different complexity of tasks, a complexity of the task (210). In some implementations, determining the complexity of the task includes determining one or more complexity rules that apply to the task.

The task assignment subsystem 116 can determine whether one of the complexity rules indicates that an entity in a default tier should process the task (220). In some implementations, determining whether one of the complexity rules indicates that an entity in the default tier should process the task includes determining whether the complexity of the task satisfies the complexity threshold. In some implementations, the default tier includes a lowest level tier, e.g., first tier 102 of the tier hierarchy 101.

If the complexity rules indicate that an entity in the default tier should process the task, the task assignment subsystem 116 can assign the task to a default tier in the tier hierarchy to enable all of the entities in the default tier to work on different portions of the task (225).

If one of the complexity rules does not indicate that an entity in the default tier should process the task, the task assignment subsystem 116 can identify a highest level tier that is indicated by at least one of the one or more complexity rules (230). In some implementations, identifying the highest level tier that is indicated by at least one of the one or more complexity rules uses data for the one or more complexity rules. In some implementations, the identified highest level tier, e.g., second tier 108, is not the highest level tier, e.g., third tier 112.

The task assignment subsystem 116 can assign the task the identified highest level tier is indicated by at least one of the one or more complexity rules (240). For example, the task assignment subsystem 116 can determine that three complexity rules of the assignment rules 122 apply to a task, e.g., an escalation rule, an overflow, and an override rule. Using the escalation rule, the task assignment subsystem 116 can determine that the task should be elevated from the default tier, e.g., first tier 102, to the second tier 108, due to the complexity of the task. Using the overflow rule and the assignment status of entities within the second tier 108, the task assignment subsystem 116 can determine that the task should be elevated to the third tier when the entities in the second tier, either collectively or individually, satisfy an assignment threshold and should not be assigned more tasks. Using the override rule, the task assignment subsystem 116 can determine that the task should be assigned to an entity within the default tier, e.g., first tier 102. This can occur, for example, when, although the task is complex, the task includes a simple calculation that, according to the override rules, should be assigned to the default tier. If not for the override rules, in this example, the task assignment subsystem 116 would assign the task to the third tier 112, instead of the default tier given the application of both the escalation rule and the overflow rule. If no rules applied, the task assignment subsystem 116 would assign the task to the default tier or the lowest level complexity tier when the lowest level complexity tier is not already the default tier.

In some implementations, the task assignment subsystem 116 assigns the task to two entities within the default tier or the identified highest level tier. In some implementations, the task assignment subsystem 116 assigns the task to all of the entities within the default tier or the identified highest level tier.

In some implementations, the process 200 can include additional steps, fewer steps, or some of the steps can be divided into multiple steps. For example, the process 200 can include retrieving data that is necessary to complete the task before determining a complexity of the task, determining whether the one or more complexity rules apply to the task, or both.

Assigning tasks with the assignment rules can lead to the data being stored in a database for a shorter period of time compared to if the tasks were not assigned to the appropriate tier, since, in some implementations, the data to complete the task does not have to be stored once the task is complete. For example, if the tasks are processed more quickly as a result of assigning the task to the default tier, the data is stored for reduced period of time compared to the period of time that a different entity in a different tier would have taken to complete the task. Reducing the amount of time the data is stored in the database can result in more available memory in the database, reduced computer resources in maintaining the database, or both.

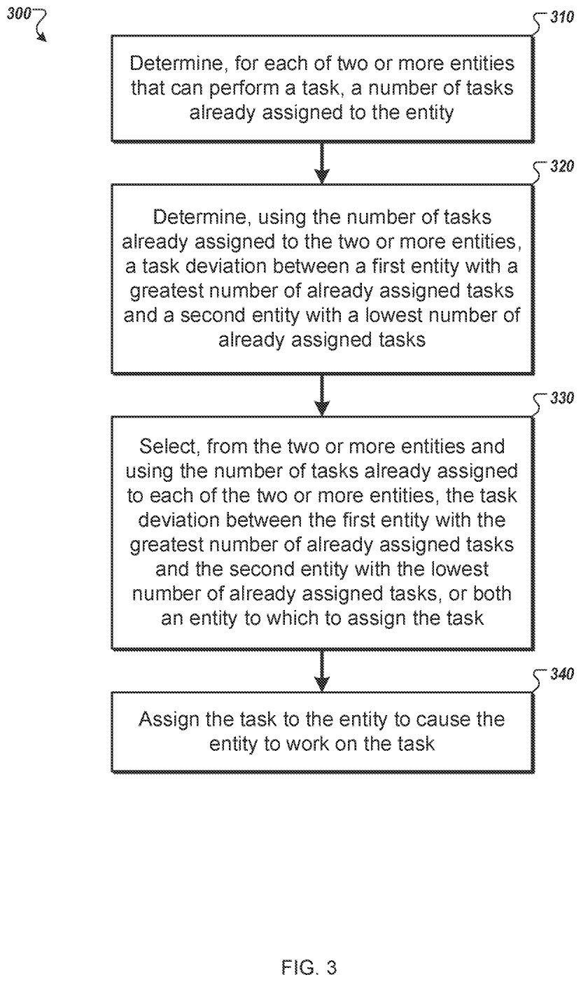

FIG. 3 is a flow diagram of a process for dynamically assigning tasks. For example, the process 300 can be used by the system 100.

The system 100 can determine, for each of two or more entities that can perform a task, a number of tasks already assigned to the entity (310).

The system 100 can determine, using the number of tasks already assigned to the two or more entities, a task deviation between a first entity with a greatest number of already assigned tasks and a second entity with a lowest number of already assigned tasks (320).

The system 100 can select, from the two or more entities and using the number of tasks already assigned to each of the two or more entities, the task deviation between the first entity with the greatest number of already assigned tasks and the second entity with the lowest number of already assigned tasks, or both, an entity to which to assign the task (330). For instance, the system can use a process, e.g., a round-robin process, to determine the next entity in an entity tier. The system can determine whether assigning the task to the next entity would violate an assignment rule that requires that the task deviation satisfies a deviation threshold. If the task deviation would not satisfy the deviation threshold, the system can determine another entity in the entity tier, e.g., using round-robin. The system can then repeat the task deviation analysis for the other entity.

The system 100 can assign the task to the entity to cause the entity to work on the task (340). Assigning the task to the entity can include sending, to the entity, data about the task to cause the entity to work on the task.

In some implementations, the process 200 can include additional steps, fewer steps, or some of the steps can be divided into multiple steps. For example, the process 300 can further include determining, for a task, a complexity of the task. When the process 300 includes determining the complexity of the task, determining the number of tasks can include determining, for each of the two or more entities that can perform the task given the complexity of the task, the number of tasks already assigned to the entity. When the process 300 uses complexity, the process 300 can determine a complexity score for the tasks already assigned to the entity and a composite complexity score that indicates a combination of the complexities of the tasks already assigned to the entity. The system can then use the composite complexity score to select an entity to which to assign the task.

In some implementations, selecting the entity to which to assign the task uses a “round-robin” technique. Round-robin techniques can include cyclically assigning tasks in equal proportions to entities within a tier. For example, if all of the entities within a tier have the same number of already assigned tasks, the system 100 can select a first entity of the entities for assigning the task. If the system 100 has to assign another task to the remaining entities within the tier that have the same number of already assigned tasks, the system can select a first entity of the remaining entities for assigning the task, and so on and so forth.

In some implementations, selecting the entity to which to assign the task includes following an overflow rule. For example, if assigning the task to any entity in a given tier would violate an overflow rule, the system 100 can determine to escalate the task to a higher tier.

In some implementations, selecting the entity to which to assign the task includes determining, using the task deviation, whether assigning the task to a particular entity would result in the particular entity having more than a fixed number of tasks within a time period, e.g., a day. If selecting the particular entity would result in the particular entity having more than a fixed number of tasks within the time period, the system 100 can escalate the task to a higher tier.

In some implementations, selecting the entity to which to assign the task includes determining whether more than a predetermined number of tasks have been assigned, during a time period, to the particular entity. This can be irrespective of the total number of tasks assigned to the particular entity. For instance, the system 100 can assign, during the time period, at most the predetermined number of tasks to the entity. If an additional task needs assignment during the time period, the system 100 can determine to assign the task to another entity.

In some implementations, selecting the entity to which to assign the task includes determining whether assigning the task to a particular entity would result in the task deviation between the particular entity and the rest of the entities be more than a fixed number of tasks within a time period. If selecting a particular entity will result in the particular entity having more than the fixed number of tasks within a time period compared to the other entities, the system can escalate the task to a higher tier.

In some implementations, the entity can be a computer or a human or a combination of both, e.g., a human using a computer. For instance, a task can be processing an insurance claim, e.g., determining a payment amount for a customer with insurance. The first tier 102 can include computers that can access input data related to customers, weather events, news stories, and the like. The computers in the first tier 102 or another system can, using the data already available to the computers, build decision trees that determine what questions to ask a customer in order to have all of the information necessary to process the claim before an entity in a higher tier, e.g., a person with a computer, starts working on the task. The instructions executed on the computer can indicate to ask as few questions as possible to receive all of the necessary information, e.g., not ask questions that have answers already available to the computers or are irrelevant to the claim being processed, choose follow up questions based on feedback sent through the user device, or both.

The task assignment subsystem 116 can determine to assign retrieving input data to the default tier, e.g., first tier 102, and the remaining portion of the task to one or both of sixth and seventh entities 110b and 110c in the second tier 108. Once the computers in the first tier 102 have retrieved all of the input data necessary to process the claim, the sixth and seventh entities 110b and 110c can begin working on the remaining, more complex, portion of the task. The remaining portion of the task can include comparing written descriptions of a natural disaster in a newspaper and the customer's claim, and other complex actions that entities in the default, first tier 102 cannot necessarily process.

A number of implementations have been described. Nevertheless, it will be understood that various modifications may be made without departing from the spirit and scope of the disclosure. For example, various forms of the flows shown above may be used, with steps re-ordered, added, or removed.

Implementations of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Implementations of the subject matter described in this specification can be implemented as one or more computer programs, i.e., one or more modules of computer program instructions encoded on a tangible non-transitory program carrier for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “data processing apparatus” refers to data processing hardware and encompasses all kinds of apparatus, devices, and machines for processing data, including by way of example a programmable processor, a computer, or multiple processors or computers. The apparatus can also be or further include special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Computers suitable for the execution of a computer program include, by way of example, general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a smart phone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., LCD (liquid crystal display), OLED (organic light emitting diode) or other monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some implementations, a server transmits data, e.g., an Hypertext Markup Language (HTML) page, to a user device, e.g., for purposes of displaying data to and receiving user input from a user interacting with the user device, which acts as a client. Data generated at the user device, e.g., a result of the user interaction, can be received from the user device at the server.

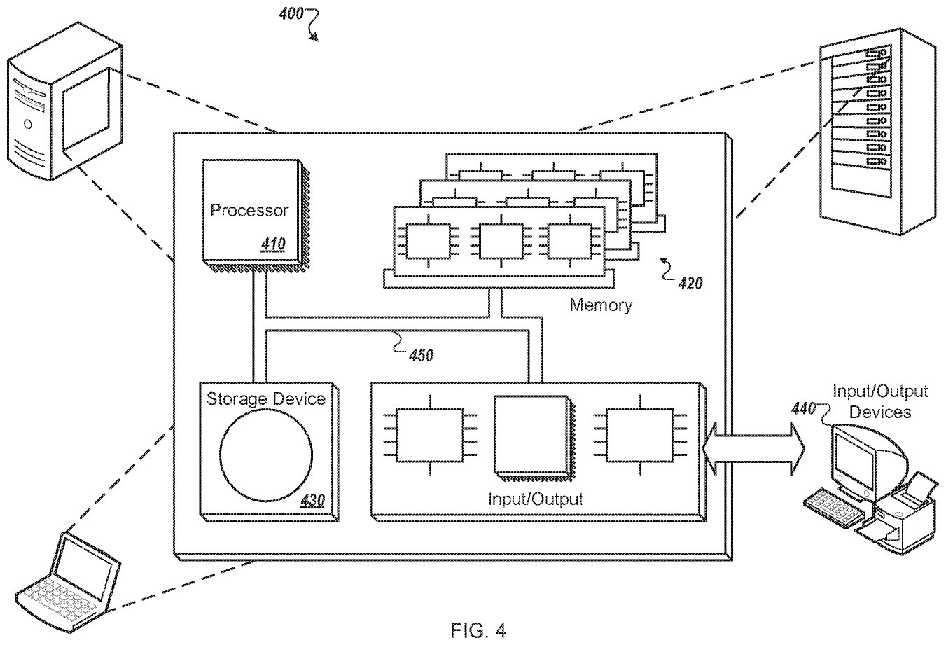

An example of one such type of computer is shown in FIG. 4, which shows a schematic diagram of a system 400. The system 400 can be used for the operations described in association with any of the computer-implemented methods described previously, according to one implementation. The system 400 includes a processor 410, a memory 420, a storage device 430, and an input/output device 440. Each of the components 410, 420, 430, and 440 are interconnected using a system bus 450. The processor 410 is capable of processing instructions for execution within the system 400. In one implementation, the processor 410 is a single-threaded processor. In another implementation, the processor 410 is a multi-threaded processor. The processor 410 is capable of processing instructions stored in the memory 420 or on the storage device 430 to display graphical information for a user interface on the input/output device 440.

The memory 420 stores information within the system 400. In one implementation, the memory 420 is a computer-readable medium. In one implementation, the memory 420 is a volatile memory unit. In another implementation, the memory 420 is a non-volatile memory unit.

The storage device 430 is capable of providing mass storage for the system 400. In one implementation, the storage device 430 is a computer-readable medium. In various different implementations, the storage device 430 may be a floppy disk device, a hard disk device, an optical disk device, or a tape device.

The input/output device 440 provides input/output operations for the system 400. In one implementation, the input/output device 440 includes a keyboard and/or pointing device. In another implementation, the input/output device 440 includes a display unit for displaying graphical user interfaces.

While this specification contains many specific implementation details, these should not be construed as limitations on the scope of what may be claimed, but rather as descriptions of features that may be specific to particular implementations. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the implementations described above should not be understood as requiring such separation in all implementations, and it should be understood that the described program components and systems can generally be integrated together in a single software product or packaged into multiple software products.

In each instance where an HTML file is mentioned, other file types or formats may be substituted. For instance, an HTML file may be replaced by an XML, JSON, plain text, or other types of files. Moreover, where a table or hash table is mentioned, other data structures (such as spreadsheets, relational databases, or structured files) may be used.

Particular implementations of the invention have been described. Other implementations are within the scope of the following claims. For example, the steps recited in the claims, described in the specification, or depicted in the figures can be performed in a different order and still achieve desirable results. In some cases, multitasking and parallel processing may be advantageous.

What is claimed is:

1. A computer-implemented method comprising:
determining, for a task to be performed by a system that includes two or more entity tiers in a tier hierarchy, each tier of which including a plurality of entities that can work on tasks and for processing a different complexity of tasks, a complexity of the task;
determining whether the complexity of the task satisfies a complexity threshold; and
in response to determining that the complexity of the task does not satisfy the complexity threshold, assigning the task to a default tier in the tier hierarchy to enable all of the entities in the default tier to work on different portions of the task.

2. The method of claim 1, wherein assigning the task to default tier comprises assigning the task to two entities of the plurality of entities for the default tier.

3. The method of claim 1, wherein assigning the task to default tier comprises assigning the task to all of the entities of the plurality of entities for the default tier.

4. The method of claim 3, wherein assigning the task to the default tier in response to determining that the complexity of the task does not satisfy the complexity threshold comprises sending, to at least one entity in the default tier, assignment data that indicates that at least one entity from the plurality of entities for the default tier will retrieve input data from a source of the task.

5. The method of claim 3, wherein assigning the task to the default tier in response to determining that the complexity of the task does not satisfy the complexity threshold comprises sending, to at least one entity in the default tier, assignment data that indicates that entities from the plurality of entities for the default tier are the only entities that will retrieve input data from a source of the task.

6. The method of claim 1, wherein data associated with the task is stored in a database for a reduced period of time, the reduced period of time being less than a period of time during which the data associated with the task would have been stored in the database if the task was assigned to a tier other than the default tier.

7. One or more non-transitory computer storage media encoded with instructions that, when executed by one or more computers, cause the one or more computers to perform operations comprising:
determining, for a task to be performed by a system that includes two or more entity tiers in a tier hierarchy each tier of which includes a plurality of entities that can work on tasks and for processing a different complexity of tasks, one or more complexity rules that apply to the task;
determining, using data for the one or more complexity rules, whether one of the complexity rules indicates that an entity in a default tier should process the task;
in response to determining that none of the complexity rules indicates that an entity in the default tier should process the task, identifying, using data for the one or more complexity rules, a highest level tier that is indicated by at least one of the one or more complexity rules; and
assigning the task to the identified highest level tier that is indicated by at least one of the one or more complexity rules.

8. The computer storage media of claim 7, wherein identifying, using the data for the one or more complexity rules, the highest level tier that is indicated by at least one of the one or more complexity rules comprises:
identifying, using first data for a first complexity rule from the one or more complexity rules, a first tier in the tier hierarchy;
identifying, using second data for a second complexity rule from the one or more complexity rules, a second tier in the tier hierarchy that processes more complex tasks than the first tier; and
selecting, as the highest level tier, the second tier from the tier hierarchy that processes more complex tasks than the first tier.

9. The computer storage media of claim 7, wherein the operations further comprise:
assigning a data input process to the default tier to cause at least one entity in the default tier to retrieve, from a source of the task, input data for the task; and
wherein assigning the task to the identified highest level tier that is indicated by at least one of the one or more complexity rules in response to determining that none of the complexity rules indicates that an entity in the default tier should process the task comprises sending, to at least one entity in the identified highest level tier, assignment data to cause an entity from the identified highest level tier to retrieve additional input data from the source of the task.

10. The computer storage media of claim 7, wherein the default tier comprises a lowest level tier in the tier hierarchy that is assigned tasks that do not satisfy a lowest complexity threshold.

11. The computer storage media of claim 7, wherein the identified highest level tier is a highest level in the tier hierarchy that is assigned tasks that satisfy a highest complexity threshold.

12. The computer storage media of claim 7, wherein the identified highest level tier is not a highest level in the tier hierarchy.

13. A system comprising one or more computers and one or more storage devices on which are stored instructions that are operable, when executed by the one or more computers, to cause the one or more computers to perform operations comprising:
determining, for each of two or more entities that can perform a task, a number of tasks already assigned to the entity;
determining, using the number of tasks already assigned to the two or more entities, a task deviation between a first entity with a greatest number of already assigned tasks and a second entity with a lowest number of already assigned tasks;
selecting, from the two or more entities and using the number of tasks already assigned to each of the two or more entities and the task deviation between the first entity with the greatest number of already assigned tasks and the second entity with the lowest number of already assigned tasks, an entity to which to assign the task; and
assigning the task to the entity to cause the entity to work on the task.

14. The system of claim 13, wherein the operations further comprise determining, for a task, a complexity of the task, wherein determining the number of tasks comprises determining, for each of the two or more entities that can perform the task given the complexity of the task, the number of tasks already assigned to the entity.

15. The system of claim 13, wherein selecting an entity to which to assign the task uses a round-robin technique for the two or more entities.

16. The system of claim 13, wherein:
a tier that comprises the two or more entities is part of a tier hierarchy each tier of which includes a plurality of entities that can work on tasks and for processing a different complexity of tasks, and
selecting the entity to which to assign the task comprises:
determining whether assigning the task to an entity of the two or more entities within the tier would violate one or more assignment rules; and
in response to determining that assigning the task to an entity of the two or more entities within the tier would not violate one or more assignment rules, determining to skip escalating the task to a higher tier than the tier within the tier hierarchy.

17. The system of claim 16, wherein at least one of the one or more assignment rules requires that a number of tasks assigned to a particular entity within a time period satisfies a task threshold.

18. The system of claim 17, wherein the task threshold is determined dynamically according to the at least one of the one or more assignment rules and tasks assigned to one or more of the two or more entities in the tier.

19. The system of claim 17, wherein the task threshold is determined using user input.

20. The system of claim 16, wherein the at least one of the one or more assignment rules require that the task deviation between two entities within the tier satisfies a deviation threshold.
